(19) United States
(12) Patent Application Publication
(10) Pub. No.: US 2024/0190728 A1
(43) Pub. Date: Jun. 13, 2024

(54) A MODULAR DRAINAGE FILTER SYSTEM FOR TREATMENT OF AGRICULTURAL DRAINAGE WATER

(71) Applicant: NOVADRAIN APS, Rødkærsbro (DK)

(72) Inventor: Charlotte Kjærgaard, Rødkaersbro (DK)

(21) Appl. No.: 18/286,660

(22) PCT Filed: Apr. 13, 2022
(86) PCT No.: PCT/DK2022/050078

§ 371 Date: Oct. 12, 2023

(30) Foreign Application Priority Data
Apr. 13, 2021 (DK) PA 2021 70172

(51) Int. Cl. C02F 1/463; C02F 1/00; C02F 1/461; C02F 1/72; C02F 101/16; C02F 103/06

(52) U.S. Cl. CPC C02F 1/463; C02F 1/001; C02F 1/46114; C02F 1/72; C02F 2101/16; C02F 2103/06; C02F 2209/001

(57) ABSTRACT

A modular drainage filter system for treatment of agricultural drainage water such as residual streams derived from agricultural activities is provided. The system has an inlet for receiving ADW, at least one bio electrochemical reactor arranged to denitrify the ADW and at least one outlet for expelling at least partly denitrified ADWT. The drainage filter system further includes one or more inlet sensors arranged upstream the BER and processing means for determining the optimal energy provided to the BER based on the data from the one or more inlet sensors thereby allowing effective operation of the drainage filter system.

### CROSS-REFERENCE TO RELATED APPLICATIONS

This application claims priority to PCT Application No. PCT/DK2022/050078, having a filing date of Apr. 13, 2022, which is based on DK Application No. PA 2021 70172, having a filing date of Apr. 13, 2021, the entire contents both of which are hereby incorporated by reference.

### FIELD OF TECHNOLOGY

The following relates to the field of filtering of drainage water especially from agricultural activities.

### BACKGROUND

Subsurface tile drainage is a major pollution pathway for agricultural nutrient losses in Denmark and worldwide, and the focus of targeted regulation. Current tile drainage losses in Denmark amount to 45-60% of the total nitrogen (N) losses (22.000 t N/yr), while national reduction targets amount to more than 15.000 N/yr.

In the USA, the EPA calls for a minimum 45% reduction in agricultural N loads for the Mississippi watershed constituting 4.4 mio km². In China fertilizer consumption has increased from 12.7 million to 41.5 million t N from 1980 to 2000, resulting in significant drainage losses. Mitigating agricultural N losses has now also become a major priority in China with 5.2 mio km² agricultural area.

Implementation of drainage filter technologies (DFTs) to reduce nutrient losses has gained major priority worldwide. Denmark is among the first countries to approve and systematically implement first generation of DFTs such as low-cost surface-flow constructed wetlands (CWs) and woodchip-based biofilters targeting agricultural drainage water (ADW)s.

Although these DFTs are highly competitive compared to field-based instruments, the current DFTs are not sufficiently effective to achieve future water quality targets, without severe implications for agricultural production. An estimated required land set-aside up to 50% of the agricultural area in Denmark and annual costs increasing to 300-455 million E have recently been published. Thus, society and the agricultural sector are facing a major challenge. The major limitation of existing DFTs are the low to medium N-reduction rates combined with large area-requirements, and implementation restrictions. Further, negative side-effects, such as increased water temperatures, release of anoxic effluents, potential for sulfide production and emissions of N₂O and CH₄, challenges implementation.

Hence, there is an urgent need for innovation to optimize and improve the efficiency and cost efficiency of DFTs, while minimizing negative side-effects.

### SUMMARY

An aspect relates to a system which effectively denitrifies agricultural drainage water (ADW) cost effectively and CO₂-eqv effectively and even CO₂-eqv neutral. Furthermore, embodiments of the present invention provide a system which can provide continuous and reliable cleaning of incoming ADW even through periods with large change in flow rates and/or level of pollution.

These and further advantages are provided by a modular drainage filter system for treatment of ADW including residual streams derived from agricultural activities, the modular drainage filter system comprising an inlet for receiving ADW, at least one bio electrochemical reactor (BER) arranged to denitrify the ADW and at least one outlet for expelling at least partly denitrified ADW, the modular drainage filter system further comprising one or more inlet sensors arranged upstream the BER and processing means for determining the optimal energy provided to the BER based on the data from the one or more inlet sensors.

By monitoring one or more parameters by one or more sensors upstream the BER and by determining and regulating the energy provided to the BER based on the data from the inlet sensors an efficient and energy optimized filter system is provided, i.e., the processing means may regulate the power in form of electricity provided to the modular drainage filter system including the BER and thereby regulate the BER operation.

In agricultural applications it is often an issue that both water flow in the residual streams, such as field drainage water, as well as the composition of the contamination in the residual streams, such as field drainage water, vary significantly over relatively short time spans.

These variations may in some situations happen periodically and/or predictably to some extent, but these variations are often dependent on for example local weather conditions.

In urban settings where more technologically advanced setups than the surface-flow constructed wetlands (CWs) and woodchip-based biofilters presently used in relation to farmlands are used, variations in the incoming water are mitigated by arrangements including for example reservoirs for containing excess water and pump systems.

However, in rural settings flow regulation via e.g., pumps are not providing feasible solutions, and thus till now DFTs such as surface-flow constructed wetlands (CWs) and woodchip-based biofilters need to be configured to maximum load in order to be able to deliver according to environmental demands at any time. In the known DFT setups maximum configuration thus requires a significant area in order to process the drainage water from the large fields most often found in modem industrial agriculture.

With embodiments of the present invention, a system is provided which allows for a hitherto unavailable flexibility in the capacity of the DFT to target highly stochastic variable field-drainage discharge in a rural agricultural setting i.e., in a system without flow regulation. The flexibility is achieved by using the input from one or more inlet sensors to regulate the energy provided to the BER as denitrification can be achieved by manipulating the applied potential and power supply. Power is provided by renewable energy sources.

This means that by embodiments of the present invention it is not the flow into the system, which is regulated as in known systems. Instead, the energy provided to the BER is regulated as control of denitrification can be achieved by controlling and manipulating the applied potential and power supply to the BER. In other words, the present system may be arranged to receive an unregulated inflow of ADW, wherein the ADW inflow may depend on e.g., local spatial and seasonally variable drainage discharge conditions.

Furthermore, ADW, as water from drainage of fields, consists mainly of oxic water from root zone percolation with no or very limited organic carbon content, and solute composition dominated by inorganic species (i.e., N in form of nitrate) and suspended mineral particles/colloids. This is in major contrast to wastewater of mainly organic origin.

The challenge of cleaning oxic ADW containing mainly inorganic contaminants such as nitrate-N and mineral particles/colloids, is substantially different from cleaning/filtering wastewater of organic origin.

In other words, the present drainage filter system is applied to contaminated waters with a composition fundamentally different to the wastewaters containing mainly organic compounds.

Furthermore, the present drainage filter system offers an unprecedented flexibility in capacity compared to known systems, especially compared to known systems with unregulated inflow as the present, due to the sensor-input based regulation of power supply to cope with the highly stochastic variable drainage loads (ADW flow rate coming into the modular system).

The inlet sensor(s) may be measuring nitrate-N concentration and/or variable water chemical parameters, temperature and/or hydraulic loading rate i.e., ADW flow rate coming into the modular system thereby providing sensor data to data processing means.

Based on the sensor data the data processing means or processor can calculate how much energy is needed for a sufficient activity of the BER at any time. The data processing means further ensures that sufficient energy is provided to the BER from one or more energy sources. The data processing means may thus provide algorithm-based control of the power supply to the drainage filter system to optimize energy supply and reduce N₂O emissions. The data processing means may e.g., be in form of one or more data processing unit.

In some embodiments a filter in form of an ECC unit is arranged upstream the BER unit, in order to remove impurities in form of suspended colloids from the influent drainage which may otherwise lead to clogging and/or lower performance and reduced lifetime of the BER.

As ADW in contrast to urban waste waters contains mainly mineral particles such as clay silicate colloids the application of an ECC in the context of ADW is significantly different from using an ECC in urban wastewater filters cleaning wastewaters of mainly organic origin.

In the context of the present application “upstream” means earlier in the flow, i.e., the sensor and filter are found prior to the BER.

The ECC filter may be provided in one or more separate modules but may be found in direct connection to the BER.

In order to further optimize the quality of the treated wastewater an oxidation step/unit may be arranged downstream the BER. For example, the anode chamber of the BER may enable oxygenation through water electrolysis. Especially in settings where the effluent from the present modular system is led to water systems such as slow-moving streams oxidation may be crucial in order to comply with local regulations. In other words, it is possible to optimize the quality of the treated wastewater and an oxidation step/unit may be arranged downstream in the BER.

In the present drainage filter system, denitrification is carried out first at the cathode part of the BER and whereafter oxidation to oxidize the at least partly denitrified stream can be carried out subsequently in the anode chamber of the BER.

In the context of the present application “downstream” means later in the flow i.e., the oxidation step is after the BER.

The oxidation step/module may be provided in one or more separate modules but may be found in direct connection to the BER.

In some embodiments the filter may comprise three modules in form of an ECC, followed by a BER followed by the filter oxidation step i.e., in the present the terms module/step/unit may be used interchangeably.

In an embodiment, the filter, BER and oxidation modules forms one single unit constructed by at least the modules containing the filter, a BER and the oxidation step.

To further optimize the system one or more sensors may be arranged by the outlet, i.e., downstream the BER in order to provide data about the effluent stream. For example, the nitrate levels in the effluent may be measured. If the outlet detector detects a higher than expected/allowed nitrate levels the energy (power) provided to the BER can be increased in order to ensure a higher activity in the BER.

The energy provided to the present modular system may be regulated to accommodate the need for sufficient/optimal effectivity of ECC, BER and/or Oxidation steps together or individually.

Thus, according to embodiments of the present invention a modular system is provided which can be tailored to use in a specific setting by choosing the appropriate sensors in order to have an optimized utilization of the BER, as well as a filter and/or an oxidation step may be implemented if advantageous.

The present modular system may be provided as independent module parts and/or as prebuilt integrated modules. For example, the oxidation step may be part of the BER module i.e., in the present the terms module/step/unit may be used interchangeably.

The electrodes of the BER unit may be in form of for example metal mesh and/or granular carbon.

The data processing means may be part of/running on a data unit specifically designed for the present use (single use) allowing data collection, processing and or storage. Alternatively, or in addition, the data processing means may be software running on one or more data units with one or more further uses (multi-use) such as a tablet, mobile phone and/or PC. The data unit, single or multi-use, may further be arranged to communicate with external units in order to ensure energy provision and for example data sharing. Data sharing may for example be beneficial in order to provide reports to regulatory authorities/agencies. The data unit may further be arranged to receive input from a user and based on this display e.g., status of the BER system, sensor data etc for example via a display and/or via shareable electronic reports.

By input from the inlet, outlet and/or remote sensors the processing means can provide an algorithm-controlled power supply and thereby regulate the effectivity of the ECC, BER and/or oxidation step.

It is understood that the system also may comprise the needed physical structures for providing energy to the filter system, sending, receiving, storing and/or processing the data from the various sensors, processing means, power supplies and/or the system itself as well as the modules it may comprise. Bio-electrochemical reactors (BER) are bioreactors where carbon as an electron donor is substituted with either a direct supply of electrons through a cathode covered by electrotrophic bacteria or by generating H₂ at the cathode as electron donor to autohydrogenotrophic bacteria, both able to perform simultaneous denitrification. Contrary to woodchip biofilters that rely on slow hydrolysis of lignocellulosic biomass, denitrification rates can be controlled and increased by control of power and applied voltage, e.g., the direct supply of electrons to the bacteria carrying out denitrification or in-situ hydrogen production via water electrolysis. BERs can attain high denitrification rates at very short Hydraulic Residence Time (HRT)s, minimizing the land area demand compared to existing competing technologies. Additionally, the anode chamber of the BER may enable oxygenation through water electrolysis. Effluents of existing DFTs lack oxygen and existing aeration approaches are very space demanding. Hence, BER-based DFTs present a unique biotechnology that can achieve both high-rate denitrification and oxygenation before water discharge.

Thus, by embodiments of the present invention is provided denitrifying DFT-based BERs and associated algorithms and real-time control system for cost-efficient reduction of N in ADW and thereby provide the required reductions relating to agricultural N mentioned in the background of embodiments of the invention. Lifetime of the present system can be improved by suspended clay colloid removal through an ECC prefilter.

### BRIEF DESCRIPTION

Some of the embodiments will be described in detail, with reference to the following figures, wherein like designations denote like members, wherein:

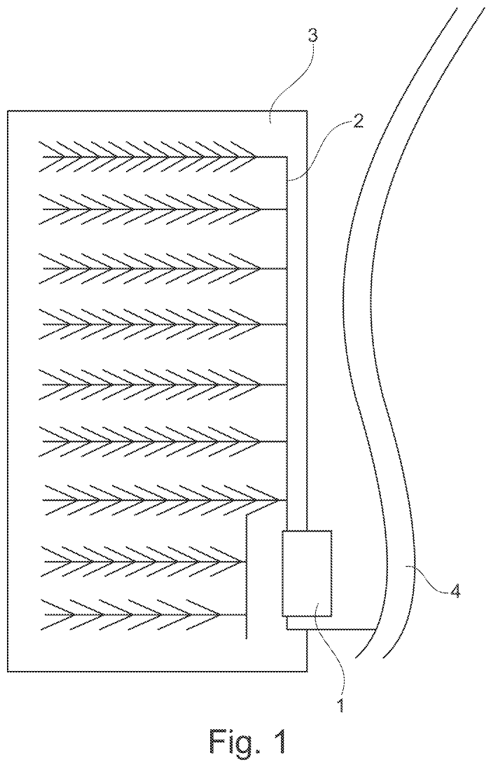

FIG. 1 shows a schematic view of a drained field and power sources in relation to a system according to embodiments of the present invention;

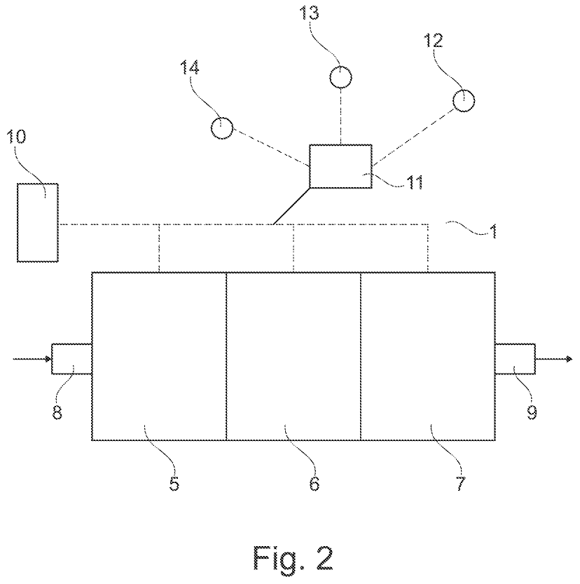

FIG. 2 shows a schematic view of a BER unit with an upstream ECC and downstream Oxidation unit; and

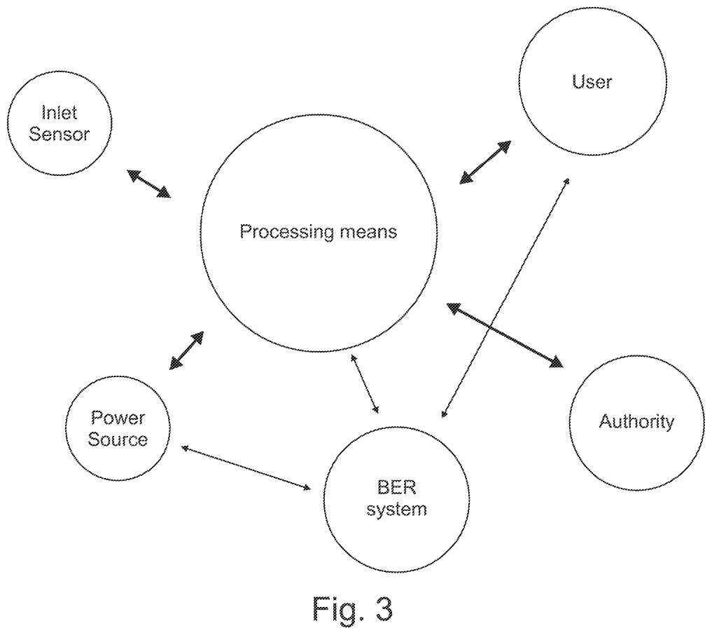

FIG. 3 shows a schematic representation of data communication between the processing means and various units.

### DETAILED DESCRIPTION

FIG. 1 shows a schematic view of a modular draining filter system according to embodiments of the present invention 1 in relation to a drainage system 2 of a field 3. The ADW from the drainage system is collected and channelled to the modular drainage filter system 1 and from the modular drainage filter system to a water stream. The size of the filter unit is highly dependent on the filter technology with an approximate area ratio of surface-flow: wood-chip: present BER technology of 1:0.2:0.001. For example, a modular system according to embodiments of the present invention may take up 10.5 m² pr. 100 ha field vs e.g., 1120 m² pr. 100 ha field for a wood chip based biofilter. The modular drainage filter system of embodiments of the present invention requires significantly less space than known solutions to achieve the required degree of denitrification.

FIG. 2 shows a schematic view of an embodiment of modular system according to the present invention 1 in a setup with three modules in form of an ECC 5 followed by a BER 6 followed by an oxidation step 7. The modules form an integrate system. The modular drainage filter system further has an inlet 8 and an outlet 9. Upstream the ECC module one or more sensors 10 are arranged to monitor at least the composition and ADW flow into the modular system. Indicated in FIG. 2 is further how the processing means 11 receives sensor input and interacts with energy providers 12 as well as provides output/input to/from the user 13 here via an app on a mobile device and in form of reports to regulatory agencies 14.

FIG. 3 illustrates an example of how the data processing means can receive data and communicate with different units such as sensors, energy sources and one or more users. The modular system comprising the BER also interacts with the data processing means as well as it may communicate with and at least receive power from one or more power supplies. Data from the BER, such as status and/or load, may be provided to a user via e.g., a mobile device.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A modular drainage filter system for treatment of agricultural drainage water (ADW), the drainage filter system comprising an inlet for receiving ADW, at least one bio electrochemical reactor (BER) module arranged to denitrify the ADW and at least one outlet for expelling at least partly denitrified ADW, the drainage filter system further comprising one or more inlet sensors arranged upstream the BER and a processing unit for determining the optimal energy provided to the BER based on the data from the one or more inlet sensors.

2. The system according to claim 1, wherein the BER is arranged to first denitrify the ADW to obtain the at least partly denitrified ADW and subsequently oxidate the at least partly denitrified ADW.

3. The system according to claim 1, wherein the one or more inlet sensors is arranged to measure N-concentrations and/or flow rate of DWT into the drainage filter system.

4. The system according to claim 1, arranged to receive an unregulated inflow of ADW.

5. The system according to claim 1, wherein a filter unit comprising an electrocoagulation colloid removal module arranged upstream the BER.

6. The system according to claim 1, wherein an oxidation module is arranged downstream the BER.

7. The system according to claim 1, wherein the BER comprises metal mesh and/or granular carbon electrodes.

8. The system according to claim 1, comprising one or more outlet sensors downstream the BER and/or one or more remote sensors, the outlet and/or remote sensors collecting data which is provided to the processing unit.

9. The system according to claim 1, wherein the at least one outlet sensor, inlet sensor and/or remote sensor are configured to measure air temperature, ground temperature, ADW temperature, flow out of the system, flow into the system, ADW composition, rain fall, time and/or weather conditions.

10. The system according to claim 1, comprising means for storing, processing, displaying and/or sending data from the downstream, inlet and/or remote sensors, data about energy provided, reports, user actions, energy consumption and/or system status.

11. The system according to claim 1, arranged to provide reports to authorities and/or users.
